(19) United States
(12) Patent Application Publication
(10) Pub. No.: US 2009/0305646 A1
(43) Pub. Date: Dec. 10, 2009

(54) AM/FM/SW RECEIVER COUPLED WITH FM TRANSMITTER FOR PERSONAL MULTIMEDIA PLAYERS FOR LISTENING AND RECORDING

(75) Inventors: John Haggis, San Jose, CA (US); John Glissman, Manilla (PH); Arthur L. Cohen, Cupertino, CA (US)

Correspondence Address: STAINBROOK & STAINBROOK, LLP, 412 AVIATION BOULEVARD, SUITE H, SANTA ROSA, CA, 95403, US

(73) Assignee: Aerielle Technologies, Inc., Mountain View, CA (US)

(21) Appl. No.: 12/162,888

(22) PCT Filed: Jan. 31, 2007
(86) PCT No.: PCT/US07/61408

§ 371 Date: Jul. 31, 2008

Related U.S. Application Data
(60) Provisional application No. 60/763,881, filed on Jan. 31, 2006.

(51) Int. Cl. H04B 1/38

(52) U.S. Cl. 455/73; 700/94

(57) ABSTRACT

An AM/FM/SW receiver coupled with an FM transmitter for personal multimedia players for both listening and recording uses innovative antenna and shielding design and placement to raise the signal-to-noise ratio of the intended broadcast content to a level which is acceptable to the listener.

### BACKGROUND OF THE INVENTION

1. Technical Field

The present invention relates generally to audio and multimedia devices, and more particularly to an improved AM/FM/SW receiver coupled with an FM transmitter for personal multimedia players for both listening and recording.

2. Background Art

Handheld multimedia players are popular personal audio and video accessories gaining greater acceptance and use every day. In addition to published music and video, these personal multimedia players are popular for delivering recorded newscasts or other spoken sources that can be transferred in multimedia file formats (e.g., “podcasts”). Some multimedia players have built-in FM receivers for receiving live transmissions of music, news or talk program content.

An increasingly popular accessory for these personal multimedia players is the FM transmitter, which allows a user to play multimedia audio through the loudspeakers of a car or home/office radio receiver without the need for interconnecting wires and receptacles. Occasionally the FM transmitter accessory is coupled with an FM receiver for personal listening of live broadcasts. This is most often the case when the multimedia player is not originally manufactured with such a receiver.

To this date, an AM radio receiver has not been known to be built into a personal multimedia player nor built into a personal multimedia player accessory. With the growing popularity of topical and timely news, talk and sports media sources, the AM broadcast band is a vast, untapped resource for personal entertainment and information in the context of the popular personal multimedia players.

A personal multimedia player or accessory that has both AM broadcast-band reception and FM broadcast-band audio transmission capabilities is a uniquely useful and strategic new type of personal audio device. The reason for its uniqueness is the technical difficulties of building an AM broadcast-band receiver in close proximity to microprocessors and related computing devices, which are at the heart of all personal multimedia players today. AM receivers are exquisitely sensitive to the noise generated by microprocessors, whose operational frequencies have fundamentals and harmonics all across the AM broadcast band. By design, AM receivers pick up and demodulate beat frequencies, fundamental waves and other RFI effects as direct audio noise.

The foregoing discussion reflects the current state of the art of which the present inventor is aware. Reference to, and discussion of, this information is intended to aid in discharging Applicant's acknowledged duty of candor in disclosing information that may be relevant to the examination of claims to the present invention. However, it is respectfully submitted that none of the prior art discloses, teaches, suggests, shows, or otherwise renders obvious, either singly or when considered in combination, the invention described and claimed herein.

### DISCLOSURE OF INVENTION

The present invention provides an improved AM/FM/SW receiver coupled with an FM transmitter for personal multimedia players for both listening and recording. The inventive device uses innovative antenna and shielding design and placement to raise the signal-to-noise ratio of the intended broadcast content to a level which is acceptable to the listener. As used herein “SW” means short wave.

It is therefore an object of the present invention to provide a new and improved personal multimedia player accessory.

It is another object of the present invention to provide a new and improved AM/FM/SW receiver.

A further object or feature of the present invention is a new and improved AM receiver coupled with an FM transmitter.

An even further object of the present invention is to provide a novel method of combining both AM broadcast-band reception and FM broadcast-band audio transmission capabilities in a personal audio device.

Other novel features which are characteristic of the invention, as to organization and method of operation, together with further objects and advantages thereof will be better understood from the following description considered in connection with the accompanying drawing, in which a preferred embodiment of the invention are illustrated by way of example. It is to be expressly understood, however, that the drawing is for illustration and description only and is not intended as a definition of the limits of the invention. The various features of novelty which characterize the invention are pointed out with particularity in the claims annexed to and forming part of this disclosure. The invention resides not in any one of these features taken alone, but rather in the particular combination of all of its structures for the functions specified.

### BRIEF DESCRIPTION OF THE DRAWINGS

The invention will be better understood and objects other than those set forth above will become apparent when consideration is given to the following detailed description thereof. Such description makes reference to the annexed drawing wherein:

FIG. 1 is a schematic view of an improved AM/FM/SW receiver coupled with an FM transmitter for personal multimedia players for both listening and recording of this invention.

### BEST MODE FOR CARRYING OUT THE INVENTION

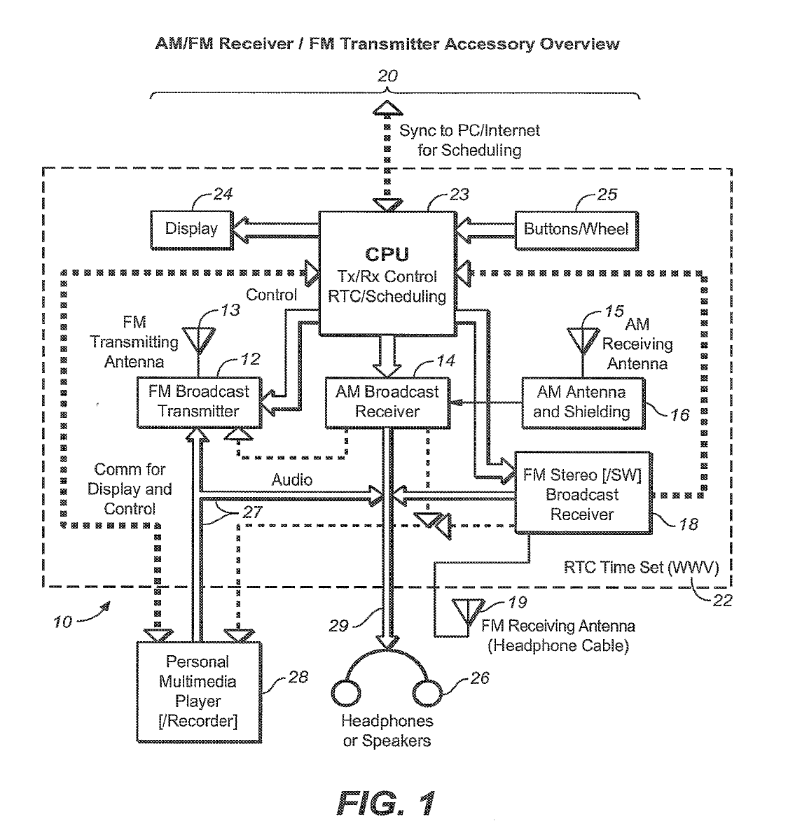

Referring to FIG. 1, there is illustrated therein a new and improved AM/FM/SW receiver coupled with an FM transmitter and recording schedule accessory for personal multimedia players for both listening and recording of this invention, generally denominated 10 herein.

The AM/FM/SW receiver/FM transmitter/recording scheduler accessory device 10 preferably includes at least two or more of the following features: an FM broadcast band transmitter 12 having an FM transmitting antenna 13, an AM broadcast band receiver 14 having an AM receiving antenna 15, AM antenna and shielding 16, an FM stereo broadcast band receiver 18 having an FM receiving antenna in a headphone cable 19, recording and scheduling 20, an SW band WWV receiver for a real time clock (“RTC”) and scheduling 22, and a processor 23 with a display 24 and interface controls (such as buttons and/or a wheel) 25 to connect to a personal computer or data network for scheduling. Live media streams or recorded data can be listened to through a headphone set or speakers 26.

The FM broadcast band transmitter 12 section takes the stereo audio output 27 of the personal multimedia player 28 and multiplexes it on a 38 KHz subcarrier. It then modulates an FM broadcast-band frequency and transmits it to an external FM radio receiver 19. The transmitter broadcast frequency may be fixed, sot by preset switches, or sot by buttons/rockers with a digital readout.

The AM broadcast band receiver 14 is based on a highly-integrated consumer-grade IC solution. This gives high selectivity and reasonable gain in a small footprint. The audio output 29 of the AM receiver (when activated) overrides the multimedia player and plays through the headphones (or external speakers) 26. When not activated, the audio 27 from the player passes through to the headphones.

The audio may also be sent into the FM transmitter 12 for transmission through the FM transmitting antenna 13 to play through an external (car/home) FM receiver in cases where local tuning (on the accessory) is more convenient than tuning on the external radio. It may also be useful in cases where the external radio is FM-only and cannot receive the desired AM broadcasts.

The audio may also be sent to the personal multimedia player if it also functions as a recorder. This ability provides for spontaneous or scheduled recording of radio programs, for time-shifting or archival purposes. This is especially useful for AM news, talk and sports programs, which have scheduling information available.

An essential and principal element in the present invention is the design and placement of the AM antenna and shielding. The objective is to minimize noise (i.e., maximize the signal-to-noise ratio). This is accomplished through a careful selection of antenna materials, the configuration of the antenna, the location relative to the microprocessor-related elements, and shielding. Audio processing within the AM receiver subsection also reduces the local RFI noise.

The FM-Stereo broadcast band receiver 18 is based on consumer-grade IC solutions. It may be combined with the AM receiver section and/or a SW receiver section in the same IC. It expands the dimensions of the accessory to the FM radio content.

Recording and scheduling 20: Assuming the personal multimedia player supports recording under the control of an external device, recording of desired programs is a key feature of this device. Though currently existing products support recording off the radio, the ability to schedule recordings offers a great advantage and unique capability.

To support scheduled recordings, the inventive device operates under its own power, includes a real-time clock (RTC) synchronized to actual time, and is able to wake up the personal multimedia player to instruct it to go into recording mode and to stop the personal multimedia player from recording.

Schedules must be downloaded in some format, either wired or wireless from a PC or Internet service where the user defines which shows to record by subject or title search and other configuration methods. As a backup, the device may allow scheduling of recordings through the hardware user interface (buttons and display, which may involve the display of the Player). The schedules input in this fashion would be based on frequency, start time, and duration (or stop time).

If an SW band receiver is available in the available IC package, it may be tuned to receive shortwave WWV time sync transmissions from a WWV time signal station (at 2.5 Mhz, 5.0 Mhz, 10.0 Mhz and/or 15.0 Mhz) to automatically set the RTC 22. This allows the device to record scheduled programs at predetermined (correct) times. The device can also display a clock and have alarm functions, playing live radio or recordings from the personal multimedia player as an alarm.

In lieu of radio time sync, the device can sync its RTC from the external communications used for downloading schedules. As a last resort the clock may be set by a manual user interface.

In addition to radio time sync, the SW (or FM) band may be used for wireless download of scheduling.

The foregoing disclosure is sufficient to enable those with skill in the relevant art to practice the invention without undue experimentation. The disclosure further provides the best mode of practicing the invention now contemplated by the inventor.

While the particular apparatus and method herein shown and disclosed in detail is fully capable of attaining the objects and providing the advantages stated herein, it is to be understood that it is merely illustrative of the presently preferred embodiment of the invention and that no limitations are intended concerning the detail of construction or design shown other than as defined in the appended claims. Accordingly, the proper scope of the present invention should be determined only by the broadest interpretation of the appended claims so as to encompass obvious modifications as well as all relationships equivalent to those illustrated in the drawings and described in the specification.

What is claimed as invention is:

1. An AM/FM/SW receiver and FM transmitter for use with a personal multimedia player, comprising:
an FM broadcast band transmitter having an FM transmitting antenna;
an AM broadcast band receiver having an AM receiving antenna;
AM shielding; and
an FM stereo broadcast band receiver having an FM receiving antenna.

2. The apparatus of claim 1, further including an SW band receiver tuned to a WWV time signal station and a real time clock, each connected to a microprocessor having recording and scheduling functionality.

3. The apparatus of claim 2, further including a display device and user interface controls which allow a user to enter instructions for scheduling program recording.

4. A combination AM/FM/SW receiver and FM transmitter for use with a personal multimedia player, comprising:
an FM broadcast band transmitter for connecting to a personal multimedia player having an audio output, wherein said FM broadcast band transmitter receives the stereo audio output of the personal multimedia player, multiplexes it on a 38 KHz subcarrier, and modulates an FM broadcast-band frequency signal for transmission;
an FM radio receiver for receiving the modulated FM broadcast-band frequency signal transmitted by said FM broadcast band transmitter;
an FM transmitting antenna connected to said FM broadcast band transmitter for broadcasting the modulated FM signal;
an FM external FM receiver for receiving the modulated FM signal;
an AM broadcast band receiver, which when activated has an audio output signal which is passed through the multimedia player audio output;
an AM antenna coupled to said AM broadcast band receiver;
a microprocess for controlling and scheduling recording operations;
AM antenna shielding for shielding said AM antenna from said microprocessor and maximizing the signal-to-noise ratio; and
a short waver receiver connected to said microprocessor and capable of being tuned to a WWV time signal station.

5. The apparatus of claim 4, wherein said AM antenna shielding is accomplished through by material selection, antenna configuration, antenna location, and shielding.

6. The apparatus of claim 5, wherein said RTC includes a wake up function to turn on the personal multimedia player and instruct it to commence recording a preidentified broadcast and/or podcast.

7. The apparatus of claim 5, wherein said microprocessor includes a wake up function to turn on the personal multimedia player and instruct it to commence recording a preidentified broadcast and/or podcast.

8. The apparatus of claim 4, further including a hardware user interface for inputting instructions into said microprocessor for scheduling recordings.
